(19) United States
(12) Patent Application Publication
(10) Pub. No.: US 2013/0080526 A1
(43) Pub. Date: Mar. 28, 2013

(54) APPARATUS AND METHOD FOR DELIVERING TARGET CONTENT TO MEMBERS ON A SOCIAL NETWORK

(71) Applicants: Barjinderpal S. Gill, Los Gatos, CA (US); Chung Ming Tam, Ottawa (CA); Paramjit Gill, Ottawa (CA); Randall Marusyk, Ottawa (CA)

(72) Inventors: Barjinderpal S. Gill, Los Gatos, CA (US); Chung Ming Tam, Ottawa (CA); Paramjit Gill, Ottawa (CA); Randall Marusyk, Ottawa (CA)

(21) Appl. No.: 13/521,653

(22) PCT Filed: Jan. 10, 2011
(86) PCT No.: PCT/CA11/50005

§ 371 Date: Nov. 21, 2012

Related U.S. Application Data
(60) Provisional application No. 61/293,796, filed on Jan. 11, 2010.

(51) Int. Cl. H04L 29/08

(52) U.S. Cl. CPC H04L 67/306
USPC 709/204

(57) ABSTRACT

A method and system for delivering targeted content to a social network having a plurality of users is provided. The method includes and the system provides for generating a multi-layer user profile for each of the users based on the individual user's activity and/or provided information. Each layer of the multi-layer user profile defines an interest and/or characteristic of the user. Grouping the users into one or more user profile groups based on the profiles such that each member of the user profile group has at least one layer in common. Retrieving and presenting content that is associate with the at least one common layer of a particular user group to all members of that particular user group.

### FIELD OF THE INVENTION

The present invention pertains to the system and method for providing targeted content to a member of a social network based on a user's profile which takes into account user activity.

### BACKGROUND OF THE INVENTION

Social networking continues to become an integral part of millions of people's daily practice. Unlike many other websites in which the duration of any one visit is relatively short, these frequently visited websites attract people for long durations. These sites facilitate the maintenance and/or development of relationships between like minded individuals who may share common interests, political views, or activities. Advertising, marketing and commerce are activities that occur on the Internet and increasingly they are expected to be carried out within social networks. However, traditional on-line marketing techniques or e-commerce have had limited success in the social networking forum. The inability to for the marketer to leverage the networking effect which forms the bases of social networks and the inherent incompatibilities between the privacy expectations of the individual and the information requirements of marketing activities. An individual in general expects their actions within a social network to be private and confidential. A marketer views actions occurring within a social network to be an opportunity to influence the decision of the individual and their peers.

The solution to the problem of leveraging networking effects within social networks is to allow the marketer to select one or more properties of the social relationship that a targeted content message is allowed to propagate. Example of properties within a social relationship includes the degree of separation and the number of connections arising from a specific user. The degree of separation represents the nodes within a social graph that contacts each user with one another. For example, a degree of separation of zero contacts the users directly with their friends. A degree of separation of one includes of the friends of the user and so on. The number of connections represents the number of user that is connected to individual on a social network at a particular degree of separation. For example, a connection number of two at a degree of separation of zero indicates that a user of a social network can connect directly with two friends. The underlying premise for the marketer in this solution is that a person's activity can influence your friends' behaviour rather then strangers. This concept can be restated in terms of degree of separation as a person's activity can influence the behaviour of others on a social network depending on the properties of the social graph. For example, it can vary with the distance on a social graph as well as the number of connections.

The problem of user privacy can be found through the definition of privacy. Privacy in essences involves control over the flow of personal information. The problem of privacy within social networks is solved if the individual can clearly control the flow of information and that a Third Party such as a marketing entity cannot uniquely identify an individual. The solution to this problem is to offer the user some form of information control and the use of aggregation methods to group users according to some common elements without revealing individual information to a third party that does have complete access to the operations of the social network.

A method and system is presented that allows a marketer to fully capture the benefits of delivering targeted content based on activities within a social network and yet still allow the user to retain their privacy. The same method and system is presented that allows a user to choose and verify his privacy settings and at the same time allow a third party to offer incentives to promote specific activities such as the access of relevant content

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an apparatus and method for third party to offer targeted content to users within a social network and for the user to control and monitor the flow of personal information such as identity or activity within a social network. The third party can offer incentives to promote a certain form of activities such as the display of targeted content or the offers of discounts in ecommerce applications.

In accordance with an aspect of the present invention, there is provided a method for a Third Party to offer targeted content and to users within a social network and for the user to control and monitor the flow of personal information. Targeted content represents text, graphics, imagines or activities that a Third Party wishes to present to a user while the user is on a Social network. Example of targeted content can be an advertising message, a graphical banner on a web page, a hypertext link or a discount offer. In addition, the method has the ability to enable a Third Party to offer incentives to promote activities within a social network having a plurality of users. Examples of activities include the clicking of a hypertext link, playing a game or carrying out an e-commerce transaction. The Third Party can control the offering of this targeted content or service to the users of a social network by defining one or more criteria chosen from two different categories: criteria arising from the properties of the social network and criteria based on group information. Examples of criteria arising from the properties of the social network include the degree of separation, the number of social connections or the definition of social relationships. Examples of group information include demographic information, network activities and personal interests.

For a third party such as a marketer, the first set of criteria arising from the properties of the social network represents the influence of the user on the user's peer group. The second set of criteria based on group information generates a multi-layer user profile for each of the plurality of users; wherein each layer of the multi-layer user profile defines an interest and/or characteristic of the user; grouping one or more users into one or more user profile groups, wherein each member of the user profile group has at least one layer in common; retrieving content that is associate with the at least one common layer of a particular user group; and presenting the content to all members of that particular user group. For the marketer, when both set of parameters are taken in combination represents the influence of an individual on his peer group for a given subject matter. The Third Party can then assign a value to the user's activity in relationship to the targeted content based on these two set criteria.

In accordance with an aspect of the present invention, there is provided a method for a user on a social network to determine their privacy setting for an activity occurring within the social network. Examples of activity are accessing a web page, navigating through the Internet or carrying out a commercial transaction. The privacy setting is allows the user to define one or more criteria chosen from two different categories: criteria arising from the properties of the social network and criteria based on group information. By controlling the set of criteria arising from the properties of the social network, the user controls the spread of his personal information through the social network. Controlling group information allows the user to choose which groups the user belongs.

In accordance with another aspect of the invention, there is provided a computer system for delivering targeted content or services to a social network comprising at least one server gathering user activities and privacy settings; the at least one server being configured to classify each user into one or more multi-layer user profile groups based on the individual user's activity and/or provided information; wherein each layer of the multi-layer user profile defines an interest and/or characteristic of the user; the at least one server being further configured to retrieve content that is associate with the at least one common layer of a particular user group; and presenting the content to all members of that particular user group

In accordance with another aspect of the invention, there is provided a method for delivering targeted content to a social network having a plurality of users, the method comprising a) generating a library of multi-layer user profiles, said library comprising a multi-layer user profile for each user in the plurality of users wherein each multi-layer user profile is based on the individual user's social graph as well as the activity on a social network and/or provided information and wherein each layer of the multi-layer user profile defines a user attribute; b) identifying a user attribute specific for the targeted content; c) identifying within the library users having multilayer user profiles having a layer consistent with the user attribute specific for the targeted content; and d) presenting the targeted content to all users identified in step c.

### BRIEF DESCRIPTION OF THE DRAWINGS

These and other features of the invention will become more apparent in the following detailed description in which reference is made to the appended drawings.

FIG. 1 is a summary of the method of this invention.

FIG. 2 is a flow chart summarizing the interactions between the Social Network Provider and a Third Party.

FIG. 3 is a flow chart illustrating the interactions between the Social Network Provider and the User.

### DETAILED DESCRIPTION OF THE INVENTION

The invention represents a method and system for providing targeted content to a member of a social network based on a user's profile, social relationships, takes into account user activity and the user's expectation of privacy.

The present invention involves three distinct and separate groups acting on information that are available on a social network. The groups are the Social Network Provider, a Third Party and the User.

A Social Network Provider provides the user with a social network that allows the user to connect to his online community and has access to the social relationships of each user. Facebook, LinkIn are representative of establish forms of social networks. A Social Network Provider has full access to the social relationships of its users and as well as information on the activities of the users while they are on the social network. A social relationship is defined as a linkage between two users on a social network. Examples of social relationships are friendships, family ties, community interests or business interactions. The social relationships on a social network can be represented by a social graph. The property of a social graph includes the degree of separation, the number of connections and the type of social relationships. The degree of separation represents the distance between nodes on a social graph. As an example, a degree of separation of zero denotes those users that are directly connected to the user (friends). They are one social node away from the user. A degree of separation of one denotes those users that are friends of your friends. The number of connections represents the number of others members of the social network connected to the user at a particular degree of separation. The type of social relationship defines the quality and context of the social relationships for example, family, business, online friendships and so on. Activities on a social network can be the browsing of web pages, the activation of hypertext links or any form of network activity including communication and game playing.

A Third Party is any one that is interested to provide information or promote an activity to one or more users on a Social Network. Typically, a Third Party represents a marketer or an interest group that wishes to present some form of targeted content to the users of a social network based on the user's activity within the social network and social relationship.

A user of a social network can connect to a social network through any computing device including computers, lap tops, portable digital assistances or cell phones. Each user has one or more social relationship on the particular social network. Each user can be uniquely identified by the Social Network Provider through its authentication and identification phase of using the social network. The user can also provide the Social Network Provider with information that can generate a multi-layer user profile which may optionally be stored on a user profile server. Examples of information includes demographic information such as age, sex, marital status, race, religion, geographical information such as place of residence, work or travel, hobbies, interests or past histories. This information can be obtained directly by querying the user or indirectly through examination of the User's network activity. A plurality of user profiles are grouped into user profile groups with each member of a specific user profile group having a common attribute.

In this system and method, the Social Network Provider provides the user with control over the distribution of information arising from the use of the social network. This control can be through an opt-in or an opt-out process. In an opt-in process, the user must explicitly agree to the activities of the Social Network Provider in dealing with the distribution of his personal information. In an opt-out process, the user must explicitly state that he is to be excluded from the activities of the Social Network Provider. The user can control the flow of his personal information through the use of two sets of parameters. The first set of parameter is based on the user's social network properties such as the degree of separation, the number of connections or the type of social relationships. The second set of parameters is based on the group profile. The two parameters together constitute a multi-layer user profile.

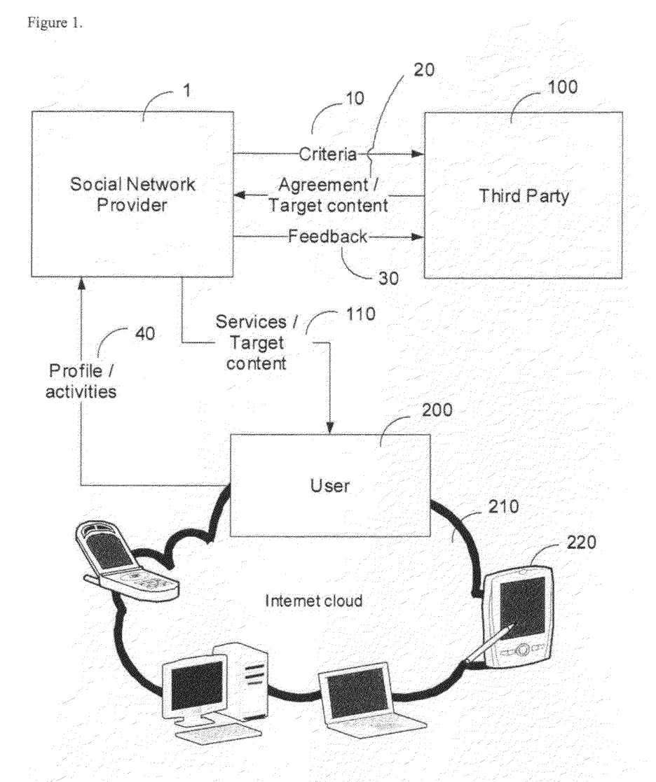

The system and method allows the Social Network Provider to provide access to a Third Party based on two or more criteria. With at least one of the criteria is a property of the Social Network and the other criteria being a multi-layer user profile that is generated based on specific user profile group with a common attribute. FIG. 1 is overall summary of this system and method. The Social Network Provider (1) provides the following information (10) to one or more Third Party (100): the available social network properties and one or more common attributes that defines a user group within the social network. The availability of this information can be explicit or implicit. The information is explicit if the Social Network Provider clearly states the available social network parameter in any agreement or communication. The information is implicit if the Social Network Provider does not directly state the criteria but offers a result guarantee. For example, a desired action within the Social Network over a period of time. The Social Network Provider and the Third Party will come to an agreement that rewards the Social Network Provider for providing the targeted content or service to their users. The details of reaching such an agreement are well known in the art. It can be through a direct fee for service which represents a payment from the Third Party to the Social Network Provider for services provided or an auction, where one or more Third Party bids for the right to offer their targeted content or service to the users. Once the acceptance of the agreement (20) is sent back to the Social Network Provider. One or more Third Party will then send the targeted content or make available the required service to the Social Network Provider (20).

The Social Network Provider then makes this content or service available to users that meet the selected criteria based on the properties of the social network and common attributes of the user profile (110). Content and service availability is also based on some predefined rules for display. The pre-defined rules for display represents conditions when a Targeted content or Service is presented and is a function of one or more of the selected criteria and the activity of the user.

The Social Network Provider can also provide feedback to the Third Party based the user's activities resulting from the availability of the targeted content (30) as well as update the common attributes of the user (40). The social network can exist on any type of network including the Internet (210), a telecommunication network or a private computer network. The User (200) can access the social network through any type of computing devices (210) such as a cell phone, a computer, a lap top or a portable digital assistant. A more detail explanation of the system and method can be found in the flowcharts describing the interactions between each of the participants.

Interaction between Social Network Provider and a Third Party

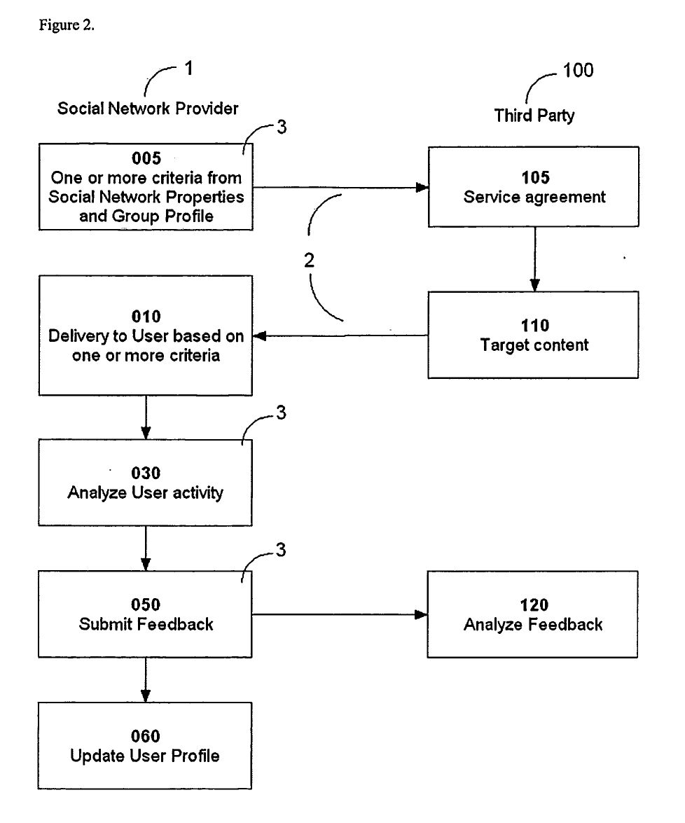

Referring to FIG. 2, a flow chart outlining the interactions between the Social Network Provider (1) and the Third Party (100), the actions of each participant (3) and the corresponding information flows (2) are described. The Social Network Provider (1) selects one or more properties of the Social Network and one or more criteria for a Group Profile to be available for a Third Party. The Third Party can use those criteria as parameters to provide content or services to one or more users within its social network. For example, one criteria being the degree of separation and a group profile generated based on demographics, relationships or activities within the social network. A Third Party then reaches a service agreement with the Social Network Provider (105). The processes for reaching this agreement are well known in the art. It can be a simple fee for service agreement, a performance based agreement or an auction process between multiple Third Parties. Once this service agreement is reached between the Social Network Provider and Third Party, the Third Party then supplies the Target content or service to the Social Network Provider (110). An example of target content could text, hyper-text or graphical imagines. An example of targeted service includes any software code or defined form of network activity. The Social Network Provider then delivers the targeted content and service to a User with the User selected based on the required criteria (10). The Social Network Provider then analyzes the User's activity in relation to those criteria and the presence of the targeted content or services (030). For example, if the user has travelled along a hyper link or used the targeted service. Information related to the targeted content or services are summarized and sent back to the Third Party (050). The Third Party can then analyze the Feedback (120). Another component to the analysis of the User's activity within the social network is the ability to update the User's profile and its corresponding Group Profile which can then be used in a new selection process for targeted content (060).

Interaction between Social Network Provider and a User

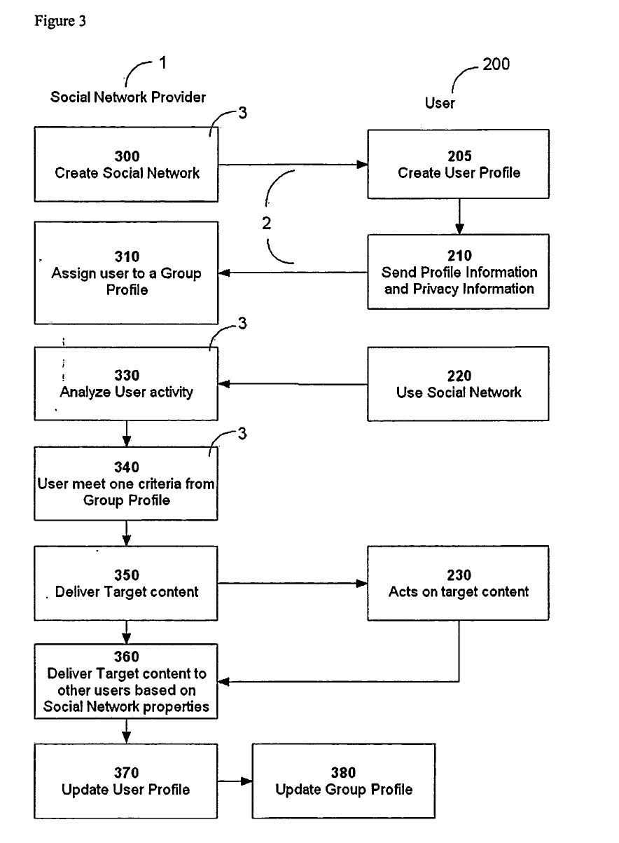

Referring to FIG. 3, a flow chart outlining the interactions between the Social Network Provider (1) and the User (200), the actions of each participant (3) and the corresponding information flows (2) are described. The Social Network Provider (1) creates a social network. The creation of social networks is well known in the art. Examples of social networks are Facebook and Link In. The criterion that defines a social network is the availability of a relationship map that describes the linkages between members within the network and this relationship map can be summarized as a social graph. A User (200) signs up to a social network by creating a User Profile (205). Amongst the information that are supplied by the User in a User Profile includes other users that the users have direct contact with (those with degree of separation of zero), demographic details, geographical locations and other information that is asked by the Social Network Provider. The User Profile can also include the User's privacy control. In which case, the user can specified the flow of his personal information as determined through the parameter of social network properties and group properties. This information is sent to the Social Network Provider (210).

The Social Network Provider then assigns the user to a Group profile based on the User's Profile information (310). When the User uses the Social Network (220), the Social Network Provider analyzes the User's activity (330). User activities that will assist in generating the profiles include, but are not limited to communications with other network users, online activities, purchases the user makes, the user's applications, ads the user clicks and websites the user visits, the user's downloads, user's chatter traffic. When the User Profile meets one of the selected criteria of the Group Profile (340), the Social Network Provider delivers the targeted content to the User (350) subject to the pre-defined rules of display. The user then acts on the targeted content (230). This action is recorded by the Social Network provider and the Social Network Provider can then deliver the Target content to other users based on the Social Network Properties and selected Group Profile criteria as initially agreed on by the Third Partner. The Social Network Provider then Update the User Profile (360). Based on this new Updated User Profile, the Social Network Provider updates the User's Group Profile (380).

In generating a user profile, user activities may be weighted or ranked such that specific activities may have a greater impact on the profile then other activities. For example, activities which are associated with a cost or a fee may be given a higher weight then those activities not associated with a cost or a fee.

In one embodiment, a repeated activity, for example a repeatedly visited website, will more greatly impact the user's profile then a one-time activity.

Optionally, a user's profile may be influenced or modified based on their friend's profiles. Cross-indexing of user profiles occurs such that a user's profile can be viewed in relation to his or her friend's profiles. In one embodiment, the method and system reviews a user's profile in the contexts of their friend's profile and adjusts the profile based on the profiles of the user's friends, such that the user's profile evolve as the user's interests and activities evolve, and as his or hers friends' profiles evolve.

The method and system provide for categorizing and grouping user profiles into user profile groups by identifying individual users whose user profiles share a common attribute or layer. The categorization of user profiles into groups is done by assessing the user's profile and comparing it with other profiles, looking for similar content. Each user can be assigned to more than one group as activities and interests vary. Users within a user profile group can be further segregated into sub-groups.

In one embodiment, user profile groups are pre-defined and users are assigned to one or more groups based on their multi-layer user profile.

Targeted content can either be based on the user profile such that potential content of interest is forwarded or can be pre-determined.

In one embodiment, having assigned user profiles into various groups, the system and method identifies content that could be successfully targeted to the group, i.e. content that is anticipated to be of interest to the group.

Optionally, the content is forwarded in a context specific manner. Context specific manner may be based on user's profiles within the group and overall group ‘state of mind’. The group's ‘status of mind’ may determined by evaluating the profiles of each user within the group, the groups evolving information content, the manner in which the user's profile is weighted and/or extrinsic factors, such as the current season of the year and any holiday that is approaching, current events.

Example of offering targeted Advertising on a Social Network

A Social Network Provider offers the following Group criteria for a Third Party under a simple fee for service agreement: 1) the Group profile degree of separation is 1 and 2) the Group profile is “Male”. The Third Party wants Social Network Provider to display a hypertext link when the user is access the social network and will pay a fee if a user clicks on the hypertext link. The display condition that the Social Network provider implemented is as follows: “When a User is Male and clicks on a link, his friends that fits the criteria of degree if separation of 1 and group characteristic of Male will get the link displayed at the earliest opportunity” In this case, a male user on the Social Network sees this hypertext link and clicks on it. As a result, his male friends and friends of his friends that are male will also see the hypertext link being displayed. The Social Network Provider then analyzes how many hypertexts links were travelled as a result of the display in a given period and charges the Third Party accordingly.

Example of offering targeted Gaming on a Mobile Social Network based on Popularity

A Social Network Provider offers the following Group criteria for a Third Party under an auction service agreement: 1) the Group profile degree of separation is 0 (2) the number of social connections must be 10 or greater and 3) the Group profile is “Location 1”. One or more Third Party wants the Social Network Provider to provide access to its game service when the user and his friends meet the requirements. Each Third Party enters an auction with the rule being the highest bidder wins the right to provide this service at a particular time. In this case, a User on the Social Network uses a portable device at Location 1.The Social Service Provider provides the winning Third Party Service to the User and correspondingly if the User's has more than then friends he gets access to the game. The Social Network then analyzes how many games were being used within the Social Network and charges the Third Party accordingly.

1. A method for delivering targeted content to a social network having a plurality of users, the method comprising:
generating a multi-layer user profile for each of the plurality of users based on the individual user's activity and/or provided information from the individual user; wherein each layer of the multi-layer user profile defines an interest and/or characteristic of the user;
grouping one or more users into one or more user profile groups, wherein each member of the user profile group has at least one layer in common;
retrieving content that is associate with the at least one common layer of a particular user group; and
presenting the content to all members of that particular user group.

2. The method of claim 1, wherein the individual user's activity comprises one or more traffic, downloads, purchases, websites visited, relationship data, applications and ads clicked.

3. The method of claim 1, wherein provided information includes user entered information and obtained information (information from IP address).

4. The method of claim 1, wherein the multi-layer user profile is a weighted profile.

5. The method of any claim 1, wherein targeted content is delivered in a context specific manner.

6. The method of claim 5, wherein context is determined based on user's browsing experience or external parameters.

7. The method of claim 6, wherein the external parameters include season or time of day.

8. A computer system for delivering targeted content to a social network comprising at least one server gathering user activities; the at least one server being configured to classify each user into one or more multi-layer user profile groups based on the individual user's activity and/or provided information from the individual user; wherein each layer of the multi-layer user profile defines an interest and/or characteristic of the user; the at least one server being further configured to retrieve content that is associate with the at least one common layer of a particular user group; and presenting the content to all members of that particular user group.

9. A method for delivering targeted content to a social network having a plurality of users, the method comprising:
a) generating a library of multi-layer user profiles, said library comprising a multi-layer user profile for each user in the plurality of users wherein each multi-layer user profile is based on the individual user's activity and/or provided information and wherein each layer of the multi-layer user profile defines a user attribute;
b) identifying a user attribute specific for the targeted content;
c) identifying within the library multilayer user profiles having a layer consistent with the user attribute specific for the target content; and
d) presenting the targeted content to all users identified in step c.

10. The method of claim 2, wherein provided information includes user entered information and obtained information (information from IP address).

11. The method of claim 2, wherein the multi-layer user profile is a weighted profile.

12. The method of claim 3, wherein the multi-layer user profile is a weighted profile.

13. The method of claim 2, wherein targeted content is delivered in a context specific manner.

14. The method of claim 3, wherein targeted content is delivered in a context specific manner.

15. The method of claim 4, wherein targeted content is delivered in a context specific manner.
